(19) United States
(12) Patent Application Publication
(10) Pub. No.: US 2025/0265114 A1
(43) Pub. Date: Aug. 21, 2025

(54) SYSTEM AND METHODS FOR MANAGING DISTRIBUTED EXECUTION OF WORKFLOWS

(71) Applicant: Shopify Inc., Ottawa (CA)

(72) Inventors: Christopher BULLOCK, Wellington (CA); Matthew TANOUS, Chattanooga, TN (US)

(73) Assignee: Shopify Inc., Ottawa (CA)

(21) Appl. No.: 18/443,600

(22) Filed: Feb. 16, 2024

(51) Int. Cl. G06F 9/48

(52) U.S. Cl. CPC G06F 9/4881

(57) ABSTRACT

A computer-implemented method is disclosed. The method includes: obtaining workflow data of a first workflow comprising a plurality of workflow steps, the workflow data defining one or more sequences of the workflow steps; initializing a batch queue by enqueuing a first job comprising at least one initial workflow step of the first workflow and a first set of workflow steps that are subsequent to the initial workflow step in the one or more sequences; and causing jobs in the batch queue to be executed by components of a distributed computing system, wherein the causing step includes, for each job in the batch queue: causing a current workflow step defined by the job to be executed; and enqueuing, to the batch queue, a new job comprising a set of workflow steps that are subsequent to the current workflow step in the one or more sequences.

### TECHNICAL FIELD

The present application relates to distributed computing and, more particularly, to a system and methods for managing distributed execution of workflows.

### BACKGROUND

The execution of workflows can be automated using job schedulers. A job scheduler is software that controls background program execution of jobs. Users may submit workflows that they want executed to a job scheduler for batch processing. A typical job scheduler implementation enables defining job dependencies, controlling execution order of jobs, and monitoring background executions in a distributed system. Scheduled jobs can be dispatched to worker systems (e.g., worker threads) for executing sequentially or in parallel.

### BRIEF DESCRIPTION OF THE DRAWINGS

Embodiments are described in detail below, with reference to the following drawings:

FIG. 1 is a schematic diagram illustrating an example configuration of a distributed computing environment;

FIG. 2A is high-level schematic diagram of an example computing device;

FIG. 2B shows a simplified organization of software components stored in a memory of the example computing device of FIG. 2A;

FIG. 3 shows, in flowchart form, an example method for managing execution of a workflow in a distributed computing environment;

FIG. 4 shows, in flowchart form, another example method for managing execution of a workflow in a distributed computing environment;

FIG. 5 shows, in flowchart form, an example method for modifying execution of a workflow in a distributed computing environment;

FIG. 6A shows an example visual representation of the steps of a workflow; and

FIG. 6B shows an example representation of a batch queue containing jobs associated with executing a workflow.

Like reference numerals are used in the drawings to denote like elements and features.

### DETAILED DESCRIPTION OF VARIOUS EMBODIMENTS

In an aspect, the present disclosure describes a computer-implemented method. The method may include: obtaining workflow data of a first workflow comprising a plurality of workflow steps, the workflow data defining one or more sequences of the workflow steps; initializing a batch queue by enqueuing a first job comprising at least one initial workflow step of the first workflow and a first set of workflow steps that are subsequent to the initial workflow step in the one or more sequences; and causing jobs in the batch queue to be executed by components of a distributed computing system, wherein the causing step includes, for each job in the batch queue: causing a current workflow step defined by the job to be executed; and enqueuing, to the batch queue, a new job comprising a set of workflow steps that are subsequent to the current workflow step in the one or more sequences.

In some implementations, obtaining the workflow data may include receiving, via a computing device, user input of the workflow data formatted in a hierarchical data structure.

In some implementations, the method may further include determining a correspondence between the workflow data and a graph representation of the plurality of workflow steps of the first workflow.

In some implementations, the method may further include determining a first directed graph including nodes that represent the plurality of workflow steps of the one or more sequences, and the causing step may further include determining a subgraph of the first directed graph corresponding to the job.

In some implementations, determining the subgraph comprises parsing the first directed graph to determine a subgraph comprising descendant nodes of a current node corresponding to the current workflow step and wherein the new job includes an indication of nodes of the subgraph.

In some implementations, the new job may be enqueued during a time delay following execution of the current workflow step.

In some implementations, the first directed graph may be a directed acyclic graph.

In some implementations, each of the plurality of workflow steps may comprise one or both of computing operations and condition evaluations.

In some implementations, causing the jobs in the batch queue to be executed may include, for each of one or more worker nodes of the distributed computing system, instructing the worker node to execute a respective one of the jobs.

In some implementations, the worker node may be instructed to execute the current workflow step and to identify the set of workflow steps.

In another aspect, the present disclosure describes a computing system. The computing system includes a processor and a memory coupled to the processor. The memory stores computer-executable instructions that, when executed by the processor, may configure the processor to: obtain workflow data of a first workflow comprising a plurality of workflow steps, the workflow data defining one or more sequences of the workflow steps; initialize a batch queue by enqueuing a first job comprising at least one initial workflow step of the first workflow and a first set of workflow steps that are subsequent to the initial workflow step in the one or more sequences; and cause jobs in the batch queue to be executed by components of a distributed computing system, wherein the causing step includes, for each job in the batch queue: causing a current workflow step defined by the job to be executed; and enqueuing, to the batch queue, a new job comprising a set of workflow steps that are subsequent to the current workflow step in the one or more sequences.

In yet another aspect, a non-transitory computer readable storage medium is disclosed. The computer readable storage medium contains instructions thereon that, when executed by a processor, configure the processor to: obtain workflow data of a first workflow comprising a plurality of workflow steps, the workflow data defining one or more sequences of the workflow steps; initialize a batch queue by enqueuing a first job comprising at least one initial workflow step of the first workflow and a first set of workflow steps that are subsequent to the initial workflow step in the one or more sequences; and cause jobs in the batch queue to be executed by components of a distributed computing system, wherein the causing step includes, for each job in the batch queue: causing a current workflow step defined by the job to be executed; and enqueuing, to the batch queue, a new job comprising a set of workflow steps that are subsequent to the current workflow step in the one or more sequences.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Workflows are a structured series of steps. To accomplish a given task, a sequence of steps associated with the task can be executed. Workflow automation is a configurable process of automating the execution of workflows. A workflow may be run automatically when triggered by an event, such as a user action within an application, or it may be triggered manually or in accordance with a defined schedule.

As a specific example, a merchant may define a workflow for onboarding new customers of a service or product. The workflow may represent various tasks associated with customer onboarding, as well as the actions/steps (e.g., account creation, customer communications, etc.) that are required to be executed to complete the tasks. When a new customer interacts with the service/product, the customer onboarding workflow may be automatically executed. In some implementations, a workflow may define a plurality of conditional sequences of steps. For example, the workflow steps may include one or more conditions, and the decision of which sequence of workflow steps to run would depend on the results of the condition evaluations.

Since workflows are composed of discrete step-by-step tasks, they are well suited for representing visually through a diagram, such as a graph (e.g., a decision tree), flowchart, wireframe, and the like. A visual representation facilitates scheduling execution of a workflow. For example, job scheduler software may use the visual representation of a workflow to define one or more jobs comprising executable steps associated with the workflow.

Assigning each step of a workflow as a separate job to execute may be inefficient, particularly when the jobs are executed on large-scale distributed systems. When a job is executed by, for example, a worker node in a distributed computing system, the node may perform querying (of one or more data sources) to obtain data that is required for executing workflow step(s) of the job. The obtained data may be saved in memory, such as RAM or cache, associated with the worker node. If each step of a workflow is scheduled as a separate job, there may be high overhead (e.g., excessive computation time, memory, etc.) on the job execution system and/or duplicated operations by the worker nodes. As a consequence, the job execution system may suffer from long execution times and large consumption of processing resources even for relatively simple workflows.

The proposed invention may introduce significant efficiencies for workflow management in a distributed computing system. Rather than adding each workflow step as a separate job in a batch queue (i.e., a job queue), the proposed system of the present application is configured to bundle, into a single job, multiple workflow steps that can be executed together. That is, the jobs in a batch queue for a workflow may include a plurality of workflow steps. In particular, each job includes a selected set of workflow steps that are subsequent to the workflow step(s) of an immediately preceding job. In some implementations, a graph representation of a workflow may be used to populate a batch queue for job scheduling. By bundling “subgraphs” comprising multiple workflow steps into a single job, the proposed invention may enable better use of computing resources when compared to an approach that schedules each individual workflow step as a separate job for execution.

A system for managing distributed execution of workflows is disclosed. Workflow data, which defines the steps of the workflow (e.g., computing operations, condition evaluations, etc.) and any time delays that are interposed between workflow steps, is inputted to the system. The input may, for example, be formatted in a hierarchical data structure, such as a tree. In some implementations, the system determines a workflow graph (e.g., a directed acyclic graph) based on the inputted workflow data. The graph comprises nodes representing the workflow steps and time delays. Starting with the root node of the graph, the system identifies a first subgraph of workflow steps that can be executed together and schedules the first subgraph as an initial job in a batch queue. That is, the workflow steps corresponding to nodes of the first subgraph are enqueued collectively as a single job in the batch queue.

The system iterates through the batch queue to execute the jobs of the workflow. Each of one or more worker nodes loads a job from the batch queue and executes the workflow steps contained in the job. This may involve performing a specific computing operation (e.g., triggering a communication or notification, etc.) and/or scheduling further job(s) for completing subsequent steps in the workflow. The workflow defines one or more possible sequences of the workflow steps. When scheduling a further job, the worker node determines a set of workflow steps that are subsequent to the current workflow step in the defined sequences and adds the set to a new job in the batch queue. In some implementations that leverage a graph representation of the workflow, the worker node may parse a subgraph, consisting of descendants of a current node, of the workflow graph and enqueue the parsed subgraph as a new job in the batch queue. For each identified subgraph, the enqueueing of the new job may occur, for example, during a time delay following execution of a current workflow step associated with the current job.

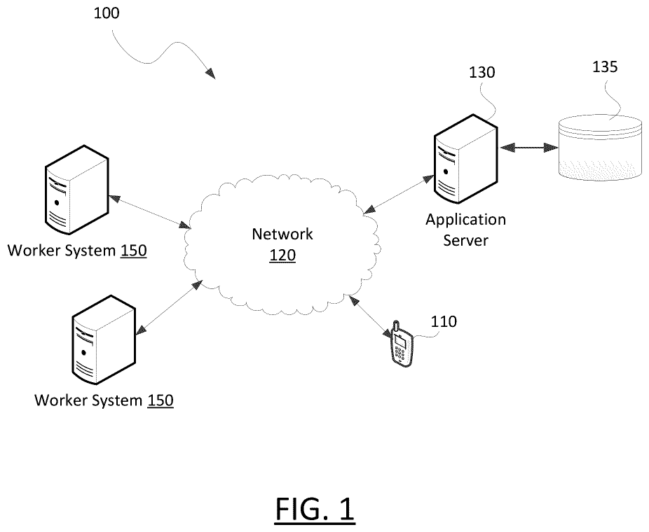

Reference is first made to FIG. 1, which is a schematic diagram illustrating an example configuration of a distributed computing environment. In particular, FIG. 1 illustrates exemplary components of a system 100 for managing distributed execution of workflows. As a specific example, the system 100 may be implemented to facilitate automated scheduling and execution of jobs associated with a workflow.

The system 100 includes an application server 130, a database 135, and worker systems 150. In at least some implementations, the components of system 100 may form part of a single computing system. By way of example, a computing system implementing an e-commerce platform may integrate the illustrated components of system 100. The e-commerce platform may be used to provide merchant products and services to customers. The components of system 100 may facilitate automating workflows relating to services provided via the e-commerce platform. Examples of customer service workflows which may be implemented by an e-commerce platform include customer onboarding workflows, order and cart workflows, issue resolution workflows, and customer feedback workflows.

As shown in FIG. 1, the system 100 includes an application server 130. The application server 130 is associated with a third-party application (e.g., a web or mobile application) or service. For example, the application server 130 may serve as a back-end system of a third-party application that is provided on client devices 110. The capabilities of the application server 130 may include, among others, user management, data storage and security, transaction processing, resource pooling, push notifications, messaging, and off-line support for the third-party application. As illustrated in FIG. 1, the application server 130 may be connected to client devices 110 and worker systems 150 via the network 120.

The application server 130 is configured to process workflows relating to the third-party application/service and automate scheduling of jobs associated with the workflows. In particular, the application server 130 may implement a workflow management service or system. The application server 130 may include a job scheduler for handling the scheduling of jobs. Workflows may relate, for example, to user journeys or flows capturing how users interact with the third-party application/service. A given workflow includes a plurality of steps. The function of the job scheduler is to determine how to assign the steps of a workflow to executable jobs. The job scheduling function of the application server 130 may be implemented in accordance with the various embodiments described in the present application.

The application server 130 is communicably coupled to a database 135. The database 135 stores application data associated with the third-party application/service as well as data that supports the job scheduling functionality of the application server 130. For example, the database 135 may store user data, application preferences and settings, workflow data of one or more workflows, list of jobs, job information (e.g., job type, set of steps, etc.) and status, list of available worker systems, assignments of jobs to worker systems, and the like.

The system 100 includes one or more worker systems 150. Each worker system 150 may be a computer system and more generally, a node in a distributed system. The worker systems 150 communicate with the application server 130 and may each be configured to execute jobs assigned by a job scheduler of the application server 130. A worker system 150 executes the workflow step(s) of an assigned job on receiving a command from the job scheduler. The command may indicate, for example, details of the job, including description of the workflow steps. The worker system 150 may provide a status update comprising results of the job execution, and the job scheduler may store the status update in the database 135.

The client devices 110, the application server 130, and the worker systems 150 may be in geographically disparate locations. Put differently, the application server 130 may be remote from the client devices 110 and the worker systems 150. As explained herein, the client device 110, the application server 130, and the worker systems 150 are computer systems.

The network 120 is a computer network. In some implementations, the network 120 may be an internetwork such as may be formed of one or more interconnected computer networks. For example, the network 120 may be or may include an Ethernet network, an asynchronous transfer mode network, a wireless network, or the like.

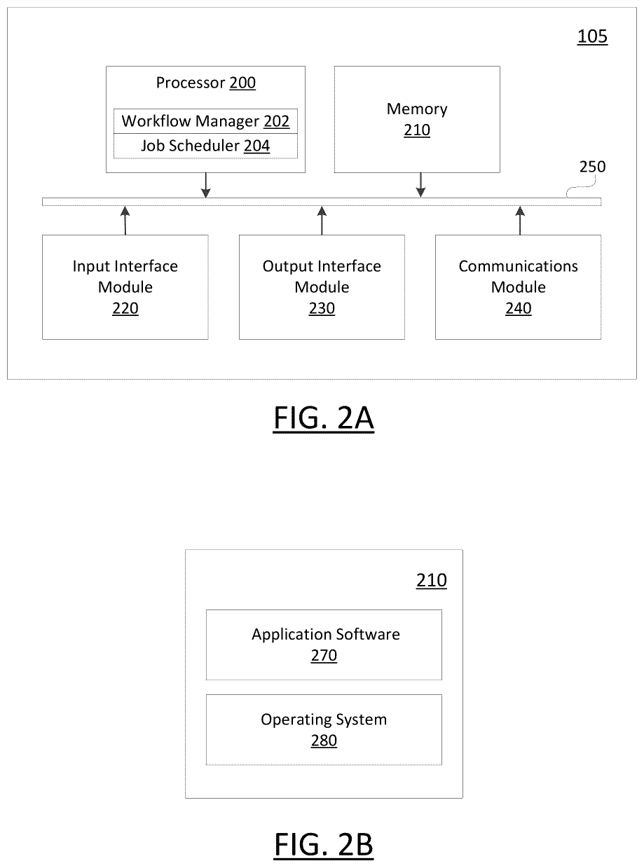

FIG. 2A is a high-level operation diagram of an example computing device 105. In at least some implementations, the example computing device 105 may be exemplary of the client devices 110, the application server 130, and the worker systems 150. The example computing device 105 includes a variety of modules. For example, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned examples of input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. The operating system 280 is software. The operating system 280 allows the application software 270 to access the processor 200, the memory 210, the input interface module 220, the output interface module 230 and the communications module 240. The operating system 280 may be, for example, Apple iOS™, Google's Android™, Linux™, Microsoft Windows™, or the like.

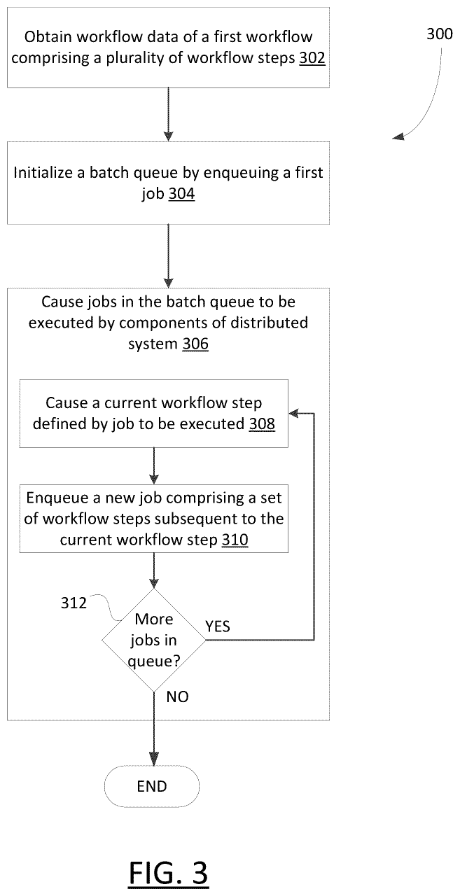

Reference is now made to FIG. 3, which shows, in flowchart form, an example method 300 for managing distributed execution of workflows. The method 300 may be implemented by a computer system that is configured to control execution of jobs in a distributed system. As a specific example, the operations of method 300 may be performed by a workflow management system (such as included in the application server 130 of FIG. 1) when implementing automated processes for handling defined workflows. Operations starting with operation 302 and continuing onward may be performed, for example, by the processor 200 (FIG. 2A) of a computing device 105 executing software comprising instructions such as may be stored in the memory 210 of the computing device 105. Specifically, processor-executable instructions may, when executed, configure a processor 200 of an application server 130 to perform all or parts of the method 300.

Workflows are defined to manage repetitive processes and tasks which occur in a particular order. A workflow typically consists of a series of individual steps that can be executed automatically. In operation 302, a workflow management system obtains workflow data of a first workflow. The first workflow comprises a plurality of workflow steps, and the workflow data defines one or more sequences of the workflow steps. That is, the workflow steps are ordered and arranged into sequences.

The workflow steps may include, for example, computing operations and condition evaluations. In particular, the workflow data may indicate one or more conditions that need to be evaluated in order to proceed with executing workflow steps. The sequences of workflow steps may thus represent possible paths of workflow execution. Each path includes workflow steps which may be executed sequentially. The decision of which path to run depends on, at least, the condition evaluations that are performed during workflow execution. Alternatively, in some implementations, multiple different paths may be executed. For example, the workflow data may identify sequences of workflow steps that are to be executed in parallel.

In at least some implementations, the workflow data of the first workflow may be received via a computing device. For example, a merchant may operate an online store offering the merchant's products and may define one or more customer service workflows (e.g., customer onboarding workflow, order and cart workflow, etc.) in connection with the online. The workflows may be designed to execute automatically in response to certain defined events or customer actions in the online store. The workflows defined by the merchant may be inputted to the workflow management system using the merchant's computing device. The inputted workflow data may take various different forms. For example, the workflow data may be formatted as a list of sequences of steps, one or more flowcharts, a directed graph, or a hierarchical data structure such as a tree.

In operation 304, the workflow management system initializes a batch queue by enqueueing a first job. A batch queue contains an ordered list of jobs to run. The batch queue is a first-in, first-out queue, such that jobs are processed in the order in which they are added to the batch queue. A job scheduler associated with the workflow management system may maintain the batch queue. The first job comprises at least one initial workflow step of the first workflow and a first set of workflow steps that are subsequent to the initial workflow step in the one or more sequences. The initial workflow step is the first step, or starting point of execution, in the first workflow. For the first job in the batch queue, the initial workflow step is a step that is required to be performed as part of execution of the job (i.e., a current workflow step for the job). In particular, when a worker system loads the first job, the initial workflow step is identified as a step that must be performed.

The first set of subsequent steps is a subset of the set of all steps in the first workflow. As explained above, the first workflow comprises one or more sequences of workflow steps. The first set contains select steps from the set of all steps that are subsequent to the initial workflow step. The first workflow may include one or more conditions that need to be evaluated. Based on the results of the condition evaluations, the possible paths of execution, i.e., selected sequences of steps, of the first workflow may be determined. That is, the decisions rendered at the condition evaluations determine the possible paths to run for the first workflow.

For example, the first job may include an additional step of evaluating a condition after the initial workflow step (for example, during a time delay immediately following the initial workflow step). The condition evaluation enables identifying a subset of the sequences (“first sequences”) that can be executed, i.e., sequences corresponding to the possible paths of execution, and other sequences that will not be executed. The first set is determined by identifying the steps that are subsequent to the current workflow step in the first sequences.

The workflow management system causes jobs in the batch queue to be executed by components of a distributed computing system (operation 306). More particularly, the workflow management system iterates over the batch queue to cause one or more worker systems to execute the jobs in the batch queue. For each of the one or more worker systems, the workflow management system instructs the worker system to execute a respective one of the jobs. The workflow management system has access to a list of worker systems that are available for executing the jobs of the workflow. The workflow management system also has access to, or may obtain, relevant information pertaining to each of the worker systems such as current workload, resource (e.g., processor and memory) capacity, currently executing job, and the like.

The job data, including job description, list of steps required to be executed, set of subsequent steps, etc., of a job in the batch queue is communicated to a worker system to which the job is assigned. The workflow management system may deliver commands relating to the assigned job to a communication endpoint for the corresponding worker system. The communication endpoint may comprise, for example, an address and a port number.

In operation 308, the workflow management system causes a current workflow step defined by the current job to be executed. More particularly, the workflow management system instructs the corresponding worker system to execute the current workflow step. As described above, each job in the batch queue identifies at least one current workflow step that is required to be performed as part of the job execution. On loading the job from the batch queue, a worker system executes the designated current workflow step, e.g., sending an email, notification, etc.

In addition to executing the required steps of the assigned job, the worker system further identifies a set of subsequent steps that are to be appended to a new job in the batch queue. The worker system provides an indication of the identified set of subsequent steps to the workflow management engine which, in turn, enqueues a new job to the batch queue comprising the set of subsequent steps (operation 310). In this way, each new job in the batch queue may include a plurality of steps which may be handled by a worker system, rather than just a single workflow step. The worker system is configured to execute a current workflow step of the current job and/or to identify a set of steps that are subsequent to the current workflow step such that the steps may be added to a new job to be enqueued. In at least some implementations, the new job may be enqueued during a time delay following execution of the current workflow step.

If there are jobs remaining in the batch queue (operation 312), the flow of control is returned to operation 308 and the workflow management system instructs a worker thread to handle execution of the next job in the batch queue.

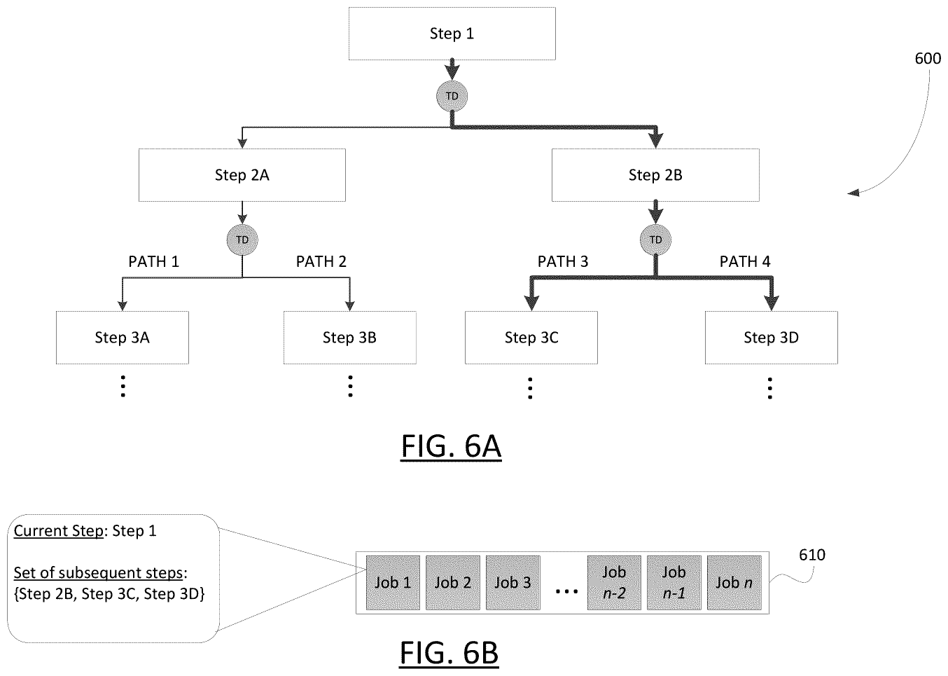

FIGS. 6A and 6B illustrate the batch queue formation based on a visual representation 600 of workflow data of an example workflow. The batch queue 610 is populated with a plurality of jobs associated with the workflow. “Job 1” indicates an initial workflow step (“Step 1”) of the workflow and a set of subsequent steps ({Step 2B, Step 3C, Step 3D}). These subsequent steps are steps that follow the initial workflow step in the sequences corresponding to the possible paths (“Path 3” and “Path 4”) of execution. The possible paths are determined at a decision point, i.e., condition evaluation, that occurs during a time delay immediately following the current workflow step, Step 1.

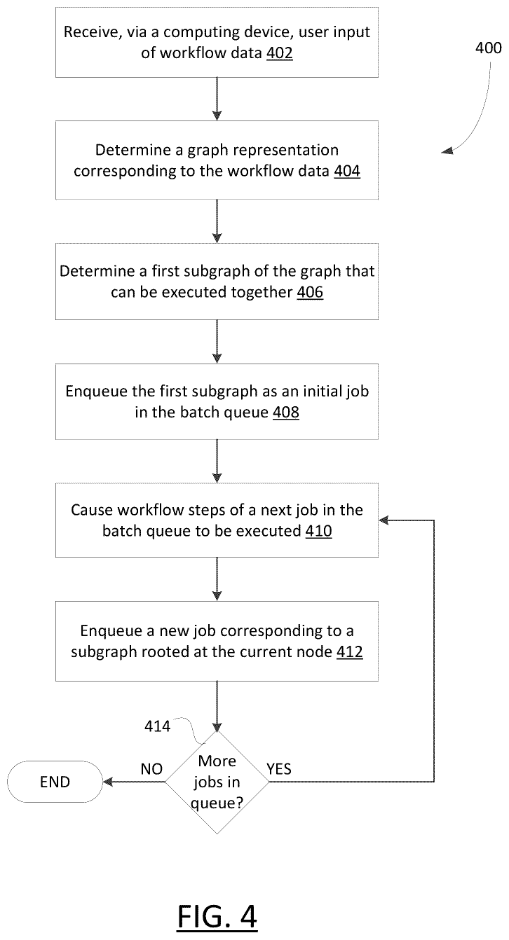

Reference is now made to FIG. 4, which shows, in flowchart form, another example method 400 for managing distributed execution of workflows. The method 400 may be implemented by a computer system, such as the application server 130, that is configured to control execution of jobs in a distributed system. Operations starting with operation 402 and continuing onward may be performed, for example, by the processor 200 (FIG. 2A) of a computing device 105 executing software comprising instructions such as may be stored in the memory 210 of the computing device 105. The operations of method 400 may be performed in addition to, or as alternatives of, one or more of the operations of method 300.

The method 400 represents a specific implementation of the job enqueuing mechanism disclosed with reference to method 300. In operation 402, a workflow management system receives, via a computing device, user input of workflow data of a first workflow. The workflow data defines the sequences of steps that need to be executed in order to accomplish various tasks. The inputted workflow data may take numerous different forms. For example, the workflow data may be formatted as a list of sequences of steps, one or more flowcharts, a directed graph, or a hierarchical data structure such as a tree.

In operation 404, the workflow management system determines a graph representation, or workflow graph, corresponding to the workflow data. More particularly, the workflow management system determines a correspondence between the workflow data and a graph representation of the plurality of workflow steps of the first workflow. In at least some implementations, the workflow graph may comprise a first directed graph, such as a directed acyclic graph. The first directed graph includes nodes that represent the plurality of workflow steps of the one or more sequences of the first workflow. The workflow management system determines the graph data, including the nodes and edges, of the workflow graph based on the workflow data of the first workflow and stores the graph data in memory.

In operation 406, the workflow management system determines a first subgraph of the first directed graph comprising steps that can be executed together. Given the graph representation of the first workflow, the set of subsequent steps corresponds to a first subgraph comprising the descendant nodes of a current node that represents the current workflow step. The first subgraph may be identified by, for example, parsing the first directed graph to identify a subgraph comprising descendant nodes of the current node. In at least some implementations, the first subgraph may include all descendant nodes of a time delay node immediately following the current workflow step.

A batch queue associated with automation of the first workflow is then initialized by enqueuing an initial job that indicates the first step, i.e., starting point of execution, of the workflow as well as the first subgraph. In particular, the workflow management system includes the first subgraph as part of the initial job in the batch queue associated with the first workflow (operation 408).

The batch queue is then populated with using the graph representation of the first workflow. The workflow management system causes the jobs in the batch queue to be executed (operation 410). In particular, the workflow management system assigns each job in the batch queue to a worker system and delivers job data of the assigned job to the corresponding worker system. The job data includes, at least, the graph data of a subgraph associated with the loaded job. On loading an assigned job from the batch queue, a worker system executes a current workflow step associated with the loaded job. The worker system further identifies a set of subsequent steps which can be executed or evaluated together for a new, i.e., future, job. The set of subsequent steps corresponds to a subgraph of the graph associated with the loaded job. The worker system may parse the graph associated with the loaded job to determine the subgraph.

The subgraph data is communicated to the workflow management system. In operation 412, the workflow management system enqueues a new job corresponding to a subgraph comprising descendant nodes of the current node to the batch queue. The new job includes an indication of the nodes of the identified subgraph. In particular, the job data of the new job specifies which of the subgraph nodes correspond to workflow steps that are required to be executed for the new job. These nodes will typically include at least the root node of the subgraph.

If there are more jobs remaining in the batch queue (operation 414), the flow of control is returned to operation 410 and the workflow management system causes a next job in the batch queue to be executed by a worker system.

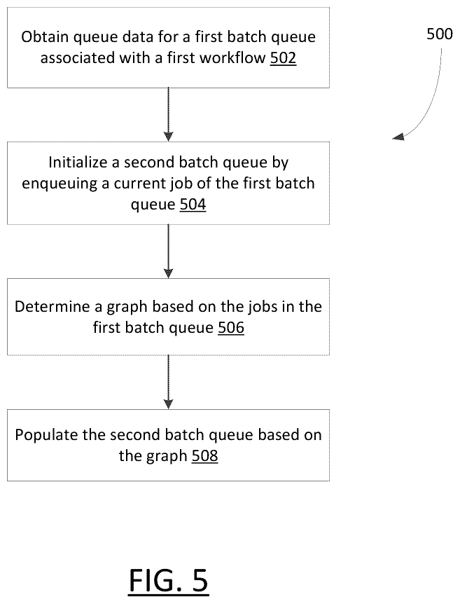

Reference is now made to FIG. 5, which shows, in flowchart form, an example method 500 for modifying execution of a workflow in a distributed computing environment. The method 500 may be implemented by a computer system, such as the application server 130, that is configured to control execution of jobs in a distributed system. Operations starting with operation 502 and continuing onward may be performed, for example, by the processor 200 (FIG. 2A) of a computing device 105 executing software comprising instructions such as may be stored in the memory 210 of the computing device 105. The operations of method 500 may be performed in addition to, or as alternatives of, one or more of the operations of methods 300 and 400.

In operation 502, a workflow management system obtains queue data for a first batch queue associated with a first workflow. The first batch queue may be a queue that is populated based on assigning each step of the first workflow as an independent job for execution. The queue data includes, at least, an ordered list of jobs in the queue.

In operation 504, the workflow management system initializes a second batch queue by enqueuing a current job of the first batch queue. The second batch queue represents a queue for the first workflow which contains jobs that are determined in accordance with the disclosed methods of the present application. In particular, the jobs of the second batch queue comprise a plurality of workflow steps that can be executed (e.g., performed or evaluated) together, as contrasted with jobs (of the first batch queue) that each contain a single individual workflow step.

The current job refers to the earliest job awaiting execution in the first batch queue. Specifically, the current job is a job that has yet to be executed and is the next job that is scheduled for execution. The job data of the current job (of the first batch queue) is used to determine the new job for initializing the second batch queue.

In operation 506, the workflow management system determines a graph based on the jobs in the first batch queue. A workflow graph corresponding to the first workflow is determined. The workflow graph includes nodes that correspond to steps of the first workflow and edges that define sequences of the workflow steps. This operation effectively builds a graph using the queue data of the first batch queue such that the graph can then be used to populate a second different batch queue. While the description refers to the specific example of a graph, such as a directed graph, other representations of the workflow steps may be used for determining new jobs to populate the second batch queue. For example, the set representation of subsequent workflow steps may be well suited for the purpose of determining new jobs.

In operation 508, the workflow management system populates the second batch queue based on the graph. New jobs that are different from the jobs of the first batch queue are determined by the workflow management system. Each new job includes a subgraph comprising nodes corresponding to workflow steps that are subsequent to one or more of the steps of a previous job. For the jobs of the second batch queue, at least one current workflow step that is required to be executed for the job is specified. Additionally, the jobs of the second batch queue include graph data for the corresponding subgraph, and this graph data may be used for identifying a further subgraph of steps for execution in a new job (of the second batch queue).

Once the second batch queue is built, the workflow management system causes the jobs of the second batch queue (and not the first batch queue) to be executed by worker systems.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above.

In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method, comprising:
obtaining workflow data of a first workflow comprising a plurality of workflow steps, the workflow data defining one or more sequences of the workflow steps;
initializing a batch queue by enqueuing a first job comprising at least one initial workflow step of the first workflow and a first set of workflow steps that are subsequent to the initial workflow step in the one or more sequences; and
causing jobs in the batch queue to be executed by components of a distributed computing system, wherein the causing step includes, for each job in the batch queue:
causing a current workflow step defined by the job to be executed; and
enqueuing, to the batch queue, a new job comprising a set of workflow steps that are subsequent to the current workflow step in the one or more sequences.

2. The method of claim 1, wherein obtaining the workflow data comprises receiving, via a computing device, user input of the workflow data formatted in a hierarchical data structure.

3. The method of claim 1, further comprising determining a correspondence between the workflow data and a graph representation of the plurality of workflow steps of the first workflow.

4. The method of claim 3, further comprising determining a first directed graph including nodes that represent the plurality of workflow steps of the one or more sequences, wherein the causing step further includes determining a subgraph of the first directed graph corresponding to the job.

5. The method of claim 4, wherein determining the subgraph comprises parsing the first directed graph to determine a subgraph comprising descendant nodes of a current node corresponding to the current workflow step and wherein the new job includes an indication of nodes of the subgraph.

6. The method of claim 1, wherein the new job is enqueued during a time delay following execution of the current workflow step.

7. The method of claim 4, wherein the first directed graph is a directed acyclic graph.

8. The method of claim 1, wherein each of the plurality of workflow steps comprises one or both of computing operations and condition evaluations.

9. The method of claim 1, wherein causing the jobs in the batch queue to be executed comprises, for each of one or more worker nodes of the distributed computing system, instructing the worker node to execute a respective one of the jobs.

10. The method of claim 9, wherein the worker node is instructed to execute the current workflow step and to identify the set of workflow steps.

11. A computing system, comprising:
a processor; and
a memory coupled to the processor, the memory storing computer-executable instructions that, when executed by the processor, configure the processor to:
obtain workflow data of a first workflow comprising a plurality of workflow steps, the workflow data defining one or more sequences of the workflow steps;
initialize a batch queue by enqueuing a first job comprising at least one initial workflow step of the first workflow and a first set of workflow steps that are subsequent to the initial workflow step in the one or more sequences; and
cause jobs in the batch queue to be executed by components of a distributed computing system, wherein the causing step includes, for each job in the batch queue:
causing a current workflow step defined by the job to be executed; and
enqueuing, to the batch queue, a new job comprising a set of workflow steps that are subsequent to the current workflow step in the one or more sequences.

12. The computing system of claim 11, wherein obtaining the workflow data comprises receiving, via a computing device, user input of the workflow data formatted in a hierarchical data structure.

13. The computing system of claim 11, wherein the instructions, when executed, further configure the processor to determine a correspondence between the workflow data and a graph representation of the plurality of workflow steps of the first workflow.

14. The computing system of claim 13, wherein the instructions, when executed, further configure the processor to determine a first directed graph including nodes that represent the plurality of workflow steps of the one or more sequences, wherein the causing step further includes determining a subgraph of the first directed graph corresponding to the job.

15. The computing system of claim 14, wherein determining the subgraph comprises parsing the first directed graph to determine a subgraph comprising descendant nodes of a current node corresponding to the current workflow step and wherein the new job includes an indication of nodes of the subgraph.

16. The computing system of claim 11, wherein the new job is enqueued during a time delay following execution of the current workflow step.

17. The computing system of claim 14, wherein the first directed graph is a directed acyclic graph.

18. The computing system of claim 11, wherein each of the plurality of workflow steps comprises one or both of computing operations and condition evaluations.

19. The computing system of claim 11, wherein causing the jobs in the batch queue to be executed comprises, for each of one or more worker nodes of the distributed computing system, instructing the worker node to execute the current workflow step and to identify the set of workflow steps.

20. A non-transitory, computer-readable medium storing instructions that, when executed by a processor, configure the processor to:
obtain workflow data of a first workflow comprising a plurality of workflow steps, the workflow data defining one or more sequences of the workflow steps;
initialize a batch queue by enqueuing a first job comprising at least one initial workflow step of the first workflow and a first set of workflow steps that are subsequent to the initial workflow step in the one or more sequences; and
cause jobs in the batch queue to be executed by components of a distributed computing system, wherein the causing step includes, for each job in the batch queue:
causing a current workflow step defined by the job to be executed; and
enqueuing, to the batch queue, a new job comprising a set of workflow steps that are subsequent to the current workflow step in the one or more sequences.
